(19) United States
(12) Patent Application Publication
(10) Pub. No.: US 2011/0068585 A1
(43) Pub. Date: Mar. 24, 2011

(54) METHOD AND SYSTEM FOR CAPTURING AND UTILIZING ENERGY GENERATED IN A FLUE GAS STREAM PROCESSING SYSTEM

(75) Inventors: Sanjay K. Dube, Knoxville, TN (US); Stephen H. Gleitz, Oak Ridge, TN (US); Frederic Z. Kozak, Knoxville, TN (US); David J. Muraskin, Knoxville, TN (US); Thomas B. Raines, Knoxville, TN (US)

(73) Assignee: ALSTOM TECHNOLOGY LTD, Baden (CH)

(21) Appl. No.: 12/849,128

(22) Filed: Aug. 3, 2010

Related U.S. Application Data
(60) Provisional application No. 61/245,436, filed on Sep. 24, 2009.

(51) Int. Cl. F03B 13/00; F02C 1/00

(52) U.S. Cl. 290/1 R; 60/407

(57) ABSTRACT

A system and process for utilizing energy generated within a flue gas processing system (100). The process includes subjecting a carbon dioxide loaded solution (142) to pressure in a regeneration system (136), thereby removing carbon dioxide from the carbon dioxide loaded solution (142) and generating a high pressure carbon dioxide stream (138). At least a portion of the high pressure carbon dioxide stream (138) is introduced to an expansion turbine (160), thereby generating energy (164). The energy (164) is utilized to generate power (168).

### CROSS REFERENCE TO RELATED APPLICATIONS

This application claims priority to U.S. Provisional Patent Application No. 61/245,436, entitled “Method and System for Capturing and Utilizing Energy Generated in a Flue Gas Stream Processing System” filed on Sep. 24, 2009, the entirety of which is incorporated by reference herein.

### FIELD

The disclosed subject matter relates to a system and method for removing carbon dioxide (CO₂) from a flue gas stream. More specifically, the disclosed subject matter relates to a system and method of capturing and utilizing energy generated during the removal of CO₂ from a flue gas stream.

### BACKGROUND

Most of the energy used in the world is derived from the combustion of carbon and hydrogen-containing fuels such as coal, oil and natural gas. In addition to carbon and hydrogen, these fuels contain oxygen, moisture and contaminants such as ash, sulfur (often in the form of sulfur oxides, referred to as “SOx”), nitrogen compounds (often in the form of nitrogen oxides, referred to as “NOx”), chlorine, mercury, and other trace elements. Awareness regarding the damaging effects of the contaminants released during combustion triggers the enforcement of ever more stringent limits on emissions from power plants, refineries and other industrial processes. There is an increased pressure on operators of such plants to achieve near zero emission of contaminants.

Numerous processes and systems have been developed in response to the desire to achieve near zero emission of contaminants. Systems and processes include, but are not limited to desulfurization systems (known as wet flue gas desulfurization systems (“WFGD”) and dry flue gas desulfurization systems (“DFGD”)), particulate filters (including, for example, bag houses, particulate collectors, and the like), as well as the use of one or more sorbents that absorb contaminants from the flue gas. Examples of sorbents include, but are not limited to, activated carbon, ammonia, limestone, and the like.

It has been shown that ammonia, as well as amine solutions, efficiently removes CO₂, as well as other contaminants, such as sulfur dioxide (SO₂) and hydrogen chloride (HCl), from a flue gas stream. In one particular application, absorption and removal of CO₂ from a flue gas stream with ammonia is conducted at a low temperature, for example, between zero (0) and twenty (20) degrees Celsius (0°-20° C.).

Removal of contaminants from a flue gas stream requires a significant amount of energy. Utilization of energy generated during the removal and processing of contaminants within a flue gas stream processing system may reduce expenses and resources required by the system.

### SUMMARY

According to aspects illustrated herein, there is provided a process for utilizing energy generated within a flue gas processing system, the process comprising providing a carbon dioxide loaded solution to a regeneration system within a flue gas processing system; subjecting the carbon dioxide loaded solution to pressure in the regeneration system thereby removing carbon dioxide from the carbon dioxide loaded solution and generating a high pressure carbon dioxide stream and a reduced carbon dioxide containing solution; introducing at least a portion of the high pressure carbon dioxide stream to an expansion turbine to reduce the pressure of the high pressure carbon dioxide stream, thereby generating energy and a low pressure carbon dioxide stream; and utilizing the energy produced in the expansion turbine to generate power, thereby utilizing the energy generated within a flue gas processing system.

According to other aspects illustrated herein, there is provided a system for utilizing energy generated during processing of carbon dioxide removed from a flue gas stream, the system comprising: an absorbing system configured to receive a carbon dioxide containing flue gas stream, wherein the carbon dioxide containing flue gas stream contacts a carbon dioxide removing solution in the absorbing system to form a reduced carbon dioxide containing flue gas stream and a carbon dioxide loaded solution; a regeneration system configured to receive the carbon dioxide loaded solution, wherein the regeneration system generates a high pressure carbon dioxide stream and a reduced carbon dioxide containing solution; an expansion turbine configured to receive at least a portion of the high pressure carbon dioxide stream to reduce the pressure of the high pressure carbon dioxide stream to produce a low pressure carbon dioxide stream and energy; and a generator in communication with the expansion turbine, the generator utilizing the energy from the expansion turbine to generate electricity.

According to other aspects illustrated herein, there is provided a process for recycling energy generated during removal of carbon dioxide from a flue gas stream, the process comprising: providing a carbon dioxide containing flue gas stream to an absorbing system; contacting the carbon dioxide containing flue gas stream with a carbon dioxide removing solution, thereby removing carbon dioxide from the flue gas stream and forming a reduced carbon dioxide containing flue gas stream and a carbon dioxide loaded solution; subjecting the carbon dioxide loaded solution to a pressure in a range between 1723.7 kpascal and 3447.4 kpascal, thereby forming a high pressure carbon dioxide stream and a reduced carbon dioxide containing solution, wherein the high pressure carbon dioxide stream has a pressure in a range between 1723.7 kpascal and 3447.4 kpascal; reducing pressure of the high pressure carbon dioxide stream to form a low pressure carbon dioxide stream and energy, the low pressure carbon dioxide stream having a pressure in a range between 68.9 kpascal and 689.5 kpascal; and utilizing the energy to provide electricity to the absorbing system, thereby recycling energy generated during removal of carbon dioxide from a flue gas stream.

The above described and other features are exemplified by the following figures and detailed description.

### BRIEF DESCRIPTION OF THE DRAWINGS

Referring now to the figures, which are exemplary embodiments, and wherein the like elements are numbered alike:

FIG. 1 is a schematic representation of a flue gas stream processing system utilized to remove contaminants from the flue gas stream.

FIG. 2 is an illustration of one embodiment of an absorbing system utilized in the system depicted in FIG. 1.

### DETAILED DESCRIPTION

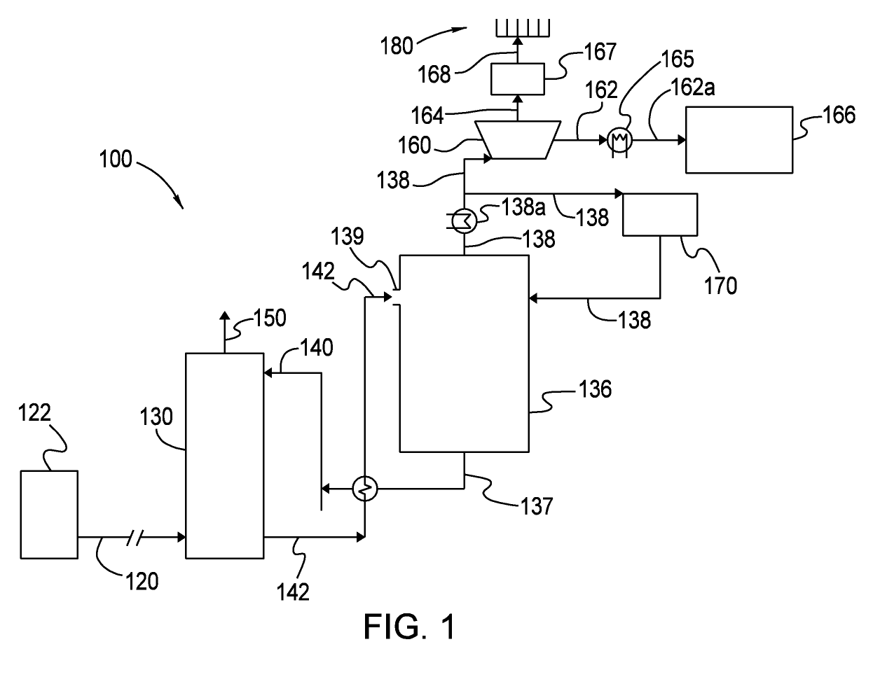

One embodiment, as shown in FIG. 1, includes a system 100 for removing contaminants from a flue gas stream 120. Flue gas stream 120 is generated by combustion of a fuel in a furnace 122. Flue gas stream 120 may include numerous contaminants, including, but not limited to, sulfur oxides (SOx), nitrogen oxides (NOx), as well as mercury (Hg), hydrochloride (HCl), particulate matter, CO₂, and the like. While not shown in FIG. 1, flue gas stream 120 may undergo treatment to remove contaminants therefrom, such as, for example, treatment by a flue gas desulfurization process and particulate collector, which may remove SOx and particulates from the flue gas.

Still referring to FIG. 1, flue gas stream 120 may also undergo treatment to remove CO₂ therefrom by passing the flue gas stream 120 through an absorbing system 130. While not shown in FIG. 1, it is contemplated that flue gas stream 120 may proceed through a cooling system prior to entering the absorbing system 130. The cooling system may cool the flue gas stream 120 to a temperature below ambient temperature.

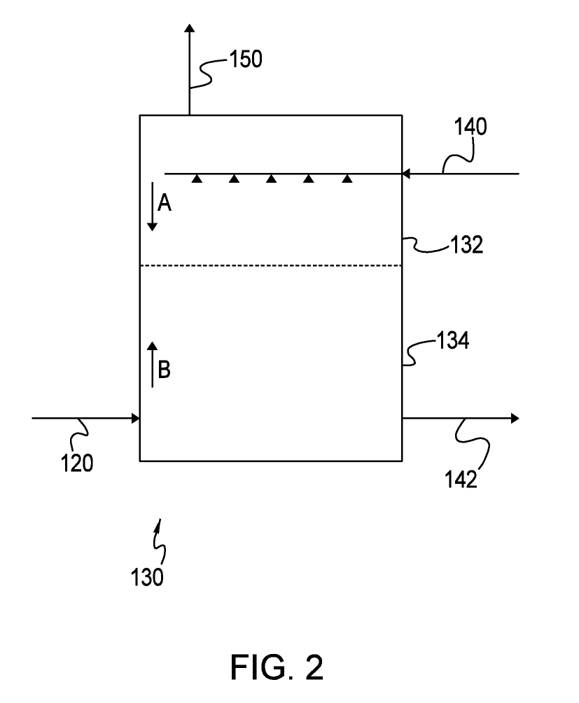

As shown in FIG. 2, the absorbing system 130 is configured to receive the CO₂ containing flue gas stream 120 (via an inlet or opening) to facilitate the absorption of CO₂ from the flue gas stream. Absorption of CO₂ from the flue gas stream 120 occurs by contacting the flue gas stream with a CO₂ removing solution 140 that is supplied to the absorbing system 130. In one embodiment, CO₂ removing solution 140 is an ammoniated solution or slurry 140 that includes dissolved ammonia and CO₂ species in a water solution and may also include precipitated solids of ammonium bicarbonate. In another embodiment, CO₂ removing solution 140 is an amine solution.

In one embodiment, the absorbing system 130 includes a first absorber 132 and a second absorber 134. Absorbing system 130 is not limited in this regard and, in other embodiments, may include more or less absorbers than illustrated in FIG. 2.

As shown in more detail in FIG. 2, CO₂ removing solution 140 is introduced to absorbing system 130. In one embodiment, the CO₂ removing solution 140 is introduced to the absorbing system in first absorber 132 in a direction A that is countercurrent to a flow of flue gas stream 120 in direction B in the absorbing system 130. As the CO₂ removing solution 140 contacts flue gas stream 120, CO₂ present in the flue gas stream is absorbed and removed therefrom, thereby forming a carbon dioxide loaded solution 142 and a reduced carbon dioxide containing flue gas stream 150 exiting the absorbing system 130. At least a portion of the resulting carbon dioxide loaded solution 142 is transported from the absorbing system 130 to a regeneration system 136 (FIG. 1) downstream of the absorbing system. In the regeneration system 136, the carbon dioxide loaded solution 142 may be regenerated to form the CO₂ removing solution 140 that is introduced to the absorbing system 130.

While the CO₂ removing solution 140 is shown in the illustrated embodiment as being introduced into the first absorber 132, the system 100 is not limited in this regard as the CO₂ removing solution may instead be introduced into the second absorber 134 or be introduced to both the first absorber and the second absorber.

In one embodiment, the absorbing system 130 operates at a low temperature, particularly at a temperature less than about twenty degrees Celsius (20° C.). In one embodiment, the absorbing system 130 operates at a temperature range of between about zero degrees Celsius to about twenty degrees Celsius (0° to 20° C.). In another embodiment, the absorbing system 130 operates at a temperature range between about zero degrees Celsius to about ten degrees Celsius (0° to 10° C.). However, the system is not limited in this regard, since it is contemplated that the absorbing system may be operated at any temperature.

Still referring to FIG. 2, the reduced carbon dioxide containing flue gas stream 150 may be subjected to further contaminant removal processes and systems prior to emission to the environment. The carbon dioxide loaded solution 142 is provided to the regeneration system 136.

Referring back to FIG. 1, regeneration system 136 may be any regeneration system configured to receive carbon dioxide loaded solution 142 and facilitate the removal of CO₂ from the carbon dioxide loaded solution to form a reduced carbon dioxide containing solution 137 and a high pressure carbon dioxide stream 138.

As shown in FIG. 1, regeneration system 136 includes an inlet 139 that introduces carbon dioxide loaded solution 142 into the regeneration system. While FIG. 1 illustrates inlet 139 located at a specific position on the regeneration system 136, it is contemplated that inlet 139 may be located at any position on the regeneration system.

In one embodiment, regeneration system 136 employs steam (not shown) to facilitate the removal of CO₂ from the carbon dioxide loaded solution 142. In another embodiment, the regeneration system is operated at a pressure in the range between about 1723.7 kpascal (about 250 pounds per square inch [gauge] (psig)) and about 3447.4 kpascal (about 500 pounds per square inch [gauge] (psig)) to remove CO₂ from the carbon dioxide loaded solution 142. In another embodiment, the regeneration system 136 may utilize a combination of steam and pressure to remove CO₂ from the carbon dioxide loaded solution 142.

As shown in FIG. 1, the reduced carbon dioxide containing solution 137 generated in regeneration system 136 may be provided to the absorbing system 130 for use with the CO₂ removing solution 140. While not shown in the illustrated embodiment, the reduced carbon dioxide containing solution 137 may combine with fresh CO₂ removing solution 140 or CO₂ removing solution that is recycled from the absorbing system 130. Alternatively, and while not shown in the illustrated embodiment, the reduced carbon dioxide containing solution 137 may be directly provided to the absorbing system 130 without combining with fresh CO₂ removing solution 140 or CO₂ removing solution recycled from the absorbing system.

In one embodiment, the carbon dioxide loaded solution 142 is subjected to pressure in the regeneration system 136. Operation of regeneration system 136 at a pressure in the range between about 1723.7 kpascal (about 250 pounds per square inch [gauge] (psig)) to about 3447.4 kpascal (about 500 pounds per square inch [gauge] (psig)) generates a high pressure carbon dioxide stream 138.

The high pressure carbon dioxide stream 138 has a pressure in the range of between about 1723.7 kpascal (about 250 pounds per square inch [gauge] (psig)) and about 3447.4 kpascal (about 500 pounds per square inch [gauge] (psig)). In one embodiment, the pressure of the high pressure carbon dioxide stream 138 is in a range between about 2068.4 kpascal (about 300 psig) and about 3447.4 kpascal (about 500 psig). In another embodiment, the pressure of the high pressure carbon dioxide stream 138 is in a range between about 2068.4 kpascal (about 300 psig) and about 3102.6 kpascal (about 450 psig). In a further embodiment, the pressure of the high pressure carbon dioxide stream 138 is about 2068.4 kpascal (about 300 psig).

As shown in FIG. 1 high pressure carbon dioxide stream 138 is provided to a heat exchanger 138a and subsequently provided to an expansion turbine 160. In one embodiment, after proceeding through heat exchanger 138a, at least a portion of high pressure carbon dioxide stream 138 may be provided to a dehydration unit 170, while a separate portion of the high pressure carbon dioxide stream 138 is provided to the expansion turbine 160.

Dehydration unit 170 removes excess moisture from the high pressure carbon dioxide stream 138 before recirculating that portion of the high pressure carbon dioxide stream back to the regeneration system 136. The moisture content of the high pressure carbon dioxide stream 138 recirculated to regeneration system 136 will be in the range between about 100 parts per million by volume (ppmv) and 600 ppmv, depending on the system and application.

While not shown, it is contemplated that all of the high pressure carbon dioxide stream 138 may be provided from the regeneration system 136 to the expansion turbine 160.

Expansion turbine 160 is configured to receive at least a portion of high pressure carbon dioxide stream 138 (by an inlet or opening) to reduce the pressure of the high pressure carbon dioxide stream and produce a low pressure carbon dioxide stream 162 and energy 164.

In one embodiment, the pressure of high pressure carbon dioxide stream 138 is reduced at least fifty percent (50%) to form the low pressure carbon dioxide stream 162. In another embodiment, the pressure of high pressure carbon dioxide stream 138 is reduced at least seventy five percent (75%) to form the low pressure carbon dioxide stream 162.

Specifically, in one embodiment, the pressure of low pressure carbon dioxide stream 162 is in a range between about 68.9 kpascal (about 10 psig) and about 1066.6 kpascal (about 140 psig). In another embodiment, the pressure of low pressure carbon dioxide stream 162 is in a range between about 68.9 kpascal (about 10 psig) and about 689.5 kpascal (about 100 psig). In another embodiment, the pressure of low pressure carbon dioxide stream 162 is in a range between about 68.9 kpascal (about 10 psig) and about 620.5 kpascal (about 90 psig). In a further embodiment, the pressure of low pressure carbon dioxide stream 162 is in a range between about 137.9 kpascal (about 20 psig) and about 206.8 kpascal (30 psig). In yet a further embodiment, the pressure of low pressure carbon dioxide stream 162 is about 137.9 kpascal (about 20 psig).

As shown in FIG. 1, low pressure carbon dioxide stream 162 is sent to a cooler 165 prior to providing a low pressure carbon dioxide stream 162a to a storage vessel 166. Low pressure carbon dioxide stream 162 may be liquefied and cooled to a temperature between about 10 degrees and 80 degrees Celsius in the cooler 165. The temperature reduction of the low pressure carbon dioxide stream 162 resulting from the pressure expansion in the expansion turbine 160 reduces the energy required by cooler 165 to lower the temperature of the low pressure carbon dioxide stream to the liquidification point.

In one embodiment, the low pressure carbon dioxide stream 162a is stored in the storage vessel 166 only temporarily before it is transported to another location for use or further processing.

Reducing the pressure of high pressure carbon dioxide stream 138 to generate low pressure carbon dioxide stream 162 in expansion turbine 160 also generates energy 164. In one embodiment, energy 164 is in the form of work that rotates a shaft of the expansion turbine 160, which in turn, is used to drive a piece of equipment, such as a generator 167. As can be appreciated, the high pressure carbon dioxide stream 138 undergoes an isentropic expansion in expansion turbine 160 and exits as low pressure carbon dioxide stream 162 having a low temperature.

As shown in FIG. 1, the energy 164 is utilized by the generator 167 to generate power 168. Generator 167 may be any type of generator that facilitates the transformation of energy 164 provided by the expansion turbine 160 to generate power 168. In one embodiment, generator 167 is an electric generator for generating electricity as the power 168.

In another embodiment, expansion turbine 160 may be coupled to a separate piece of equipment (not shown), such as a pump, a compressor, a refrigeration compressor, a fan, a blower, or the like. Energy 164 may be used to provide power to the equipment coupled to the expansion turbine 160, i.e., the energy may be the prime mover of the equipment coupled to the expansion turbine.

Power 168 produced by the generator 167 may be utilized within system 100. For example, the power 168 may be provided to and used by the power plant 122. In another example, the power 168 may be provided to and used by various devices within system 100, including, but not limited to pumps within absorbing system 130, pumps in communication with the regeneration system 136, coolers and condensers used within system 100, fans used within system 100, recycle pumps and ball mills used in connection with wet flue gas desulfurization systems used in system 100. Alternatively, or in addition to providing power 168 to devices within system 100, power 168, in the form of electricity, may be provided to a consumer electric grid 180 or another device or system outside of the system 100.

Utilization of power 168 within the system 100 alleviates, reduces or eliminates the need to obtain power from a source outside of the system. By alleviating, reducing or eliminating the need to obtain power from an outside source the system 100 may be more efficient and/or cost effective than a system that obtains power from an outside source. Efficiency and cost reduction may also be experienced by systems and devices, such as consumer electric grid 180, when power 168 is sent outside of system 100.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced item.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A process for utilizing energy generated within a flue gas processing system, the process comprising:
providing a carbon dioxide loaded solution to a regeneration system within a flue gas processing system;
subjecting the carbon dioxide loaded solution to pressure in the regeneration system thereby removing carbon dioxide from the carbon dioxide loaded solution and generating a high pressure carbon dioxide stream and a reduced carbon dioxide containing solution;
introducing at least a portion of the high pressure carbon dioxide stream to an expansion turbine to reduce the pressure of the high pressure carbon dioxide stream, thereby generating energy and a low pressure carbon dioxide stream; and
utilizing the energy produced in the expansion turbine to generate power, thereby utilizing the energy generated within a flue gas processing system.

2. A process according to claim 1, wherein the carbon dioxide loaded solution is subjected to pressure having a range between 1723.7 kpascal and 3447.4 kpascal.

3. A process according to claim 1, wherein the pressure of the low pressure carbon dioxide stream has a range between 68.9 kpascal and 1066.6 kpascal.

4. A process according to claim 1, wherein the pressure of the low pressure carbon dioxide stream is in a range between 137.9 kpascal and 206.8 kpascal.

5. A process according to claim 1, wherein the power is electricity.

6. A process according to claim 1, further comprising:
providing the low pressure carbon dioxide stream to a cooler.

7. A process according to claim 1, further comprising:
providing the low pressure carbon dioxide stream to a storage vessel.

8. A process according to claim 1, wherein the pressure of the high pressure carbon dioxide stream is in a range between 1723.7 kpascal and 3447.4 kpascal.

9. A process according to claim 1, further comprising:
providing the power to an absorbing system, wherein the absorbing system is upstream of the regeneration system and the absorbing system removes carbon dioxide from a flue gas stream.

10. A process according to claim 1, further comprising:
providing the power to a consumer electric grid.

11. A system for utilizing energy generated during processing of carbon dioxide removed from a flue gas stream, the system comprising:
an absorbing system configured to receive a carbon dioxide containing flue gas stream, wherein the carbon dioxide containing flue gas stream contacts a carbon dioxide removing solution in the absorbing system to form a reduced carbon dioxide containing flue gas stream and a carbon dioxide loaded solution;
a regeneration system configured to receive the carbon dioxide loaded solution, wherein the regeneration system generates a high pressure carbon dioxide stream and a reduced carbon dioxide containing solution;
an expansion turbine configured to receive at least a portion of the high pressure carbon dioxide stream to reduce the pressure of the high pressure carbon dioxide stream to produce a low pressure carbon dioxide stream and energy; and
a generator in communication with the expansion turbine, the generator utilizing the energy from the expansion turbine to generate electricity.

12. A system according to claim 11, wherein the regeneration system is operated at a pressure having a range between 1723.7 kpascal and 3447.4 kpascal.

13. A system according to claim 11, wherein the high pressure carbon dioxide stream has a pressure in a range between 1723.7 kpascal and 3447.4 kpascal.

14. A system according to claim 11, wherein the low pressure carbon dioxide stream has a pressure in a range between about 68.9 kpascal and 1066.6 kpascal.

15. A system according to claim 11, further comprising a cooler in communication with the expansion turbine, wherein the cooler is configured to receive the low pressure carbon dioxide stream from the expansion turbine and reduce a temperature of the low pressure carbon dioxide stream to a temperature in a range between 10 degrees Celsius and 80 degrees Celsius.

16. A system according to claim 11, further comprising a storage vessel in communication with the expansion turbine, the storage vessel adapted to store the low pressure carbon dioxide stream.

17. A system according to claim 11, wherein the carbon dioxide removing solution comprises ammonia.

18. A system according to claim 17, wherein the absorbing system is operated at a temperature between 0° Celsius and 20° Celsius.

18. A system according to claim 11, wherein the carbon dioxide removing solution is an amine solution.

19. A system according to claim 11, further comprising providing the reduced carbon dioxide containing solution to the absorbing system.

20. A process for recycling energy generated during removal of carbon dioxide from a flue gas stream, the process comprising:
providing a carbon dioxide containing flue gas stream to an absorbing system;
contacting the carbon dioxide containing flue gas stream with a carbon dioxide removing solution, thereby removing carbon dioxide from the flue gas stream and forming a reduced carbon dioxide containing flue gas stream and a carbon dioxide loaded solution;
subjecting the carbon dioxide loaded solution to a pressure in a range between 1723.7 kpascal and 3447.4 kpascal, thereby forming a high pressure carbon dioxide stream and a reduced carbon dioxide containing solution, wherein the high pressure carbon dioxide stream has a pressure in a range between 1723.7 kpascal and 3447.4 kpascal;
reducing pressure of the high pressure carbon dioxide stream to form a low pressure carbon dioxide stream and energy, the low pressure carbon dioxide stream having a pressure in a range between 68.9 kpascal and 689.5 kpascal; and
utilizing the energy to provide electricity to the absorbing system, thereby recycling energy generated during removal of carbon dioxide from a flue gas stream.
